(19) United States
(12) Patent Application Publication
(10) Pub. No.: US 2022/0364847 A1
(43) Pub. Date: Nov. 17, 2022

(54) Device and Method For Measuring A Three-Dimensional Shape Of A Structure, In Particular A Wind Turbine Blade

(71) Applicant: Fibersail Holding B.V., Amsterdam (NL)

(72) Inventors: Pedro MOURA PINTO, Portimão (PT); Pedro Gil MARQUES DE QUEIRÓS FERREIRA, Vila Nova de Gaia (PT); António VAZ RODRIGUES, Porto (PT)

(21) Appl. No.: 17/765,499

(22) PCT Filed: Oct. 2, 2020
(86) PCT No.: PCT/IB2020/059285

§ 371 Date: Mar. 31, 2022

(30) Foreign Application Priority Data
Oct. 2, 2019 (PT) 115813

(51) Int. Cl. G01B 11/16

(52) U.S. Cl. CPC G01B 11/165; G01B 11/161

(57) ABSTRACT

The present disclosure relates to the field of measuring three-dimensional shapes of 3D structures, in particular wind turbine structures like wind turbine blades, using optical fibre strain sensors, namely Fibre Bragg Gratings, FBGs. It is disclosed a device and corresponding method for measuring a three-dimensional shape of a structure by being slidably coupled to the structure such that the deformation of the structure, except lengthening or shortening, causes a corresponding deformation of the device, the device comprising: a pliant beam; three or more optical fibres arranged lengthwise in parallel within said beam and having a transversal distance between said fibres in at least two different transversal directions; wherein said optical fibres comprise a plurality of sensor regions distributed along said optical fibres, wherein each said sensor region comprises a Fibre Bragg Grating in each of the optical fibres.

### TECHNICAL FIELD

The present disclosure relates to the field of measuring three-dimensional shapes of 3D structures, in particular wind turbine structures like wind turbine blades, using optical fibre strain sensors, namely Fibre Bragg Gratings, FBGs.

### BACKGROUND

In the field of measuring 3D shapes using optical fibre strain sensors, namely Fibre Bragg Gratings, there are insufficiencies that the present disclosure addresses. In particular, there are problems relating to shape sensing systems based on FBGs.

The known shape sensing systems are based on multicore arrays of normally 3 cores. The distance between the cores are of microns which means that are not suitable for accuracy along long lengths.

Other known systems use hundreds or thousands FBGs to measure the shape of a small length structure, which means a very costly system with no general commercial application, with the exception of medical research.

The inherent round design of the fibre optic does not allow for the measurement of torsion unless it is bonded to the structure itself, and in that case to measure the shape it is then required the knowledge of the design of the original structure.

In particular, there are also problems relating to shape sensing systems based on FBGs embedded on wind turbine blades.

The use of FBGs embedded on blades has more than 20 years, but its reliability comes under question, due to high stresses of the blades, need for calibration, temperature compensation and design of original blade in order to measure reliable strains. Another issue is that huge composite structures are likely to be different from each other due to manufacturing processes and this affects the quality of measurement.

These reasons can explain that strain sensing on large structures is quite used on research and prototype testing, but not much used on the actual long-term control structures, in particular wind turbine structures due to the lack of reliability from the acquired data and devices.

These facts are disclosed in order to illustrate the technical problem addressed by the present disclosure.

### GENERAL DESCRIPTION

The present disclosure relates to the field of measuring three-dimensional shapes of 3D structures, in particular wind turbine structures like wind turbine blades, using optical fibre strain sensors, namely Fibre Bragg Gratings, FBGs.

The present disclosure includes a self-contained 3D shape sensing device and respective operation method comprising three or more single-core parallel optical arrays of FBGs embedded in a discrete composite structure with a predetermined profile, for example a rectangular pliant beam, for measuring the shape and deflection of structures such as wind turbine blades, advantageously without experiencing structural stresses, and without needing to know the exact design and profile of the blade to measure its deformation.

The present disclosure also includes a self-contained shape sensing device method and apparatus based on two or more single-core parallel optical arrays of FBGs embedded in a discrete composite profile for measuring the shape and deflection along the length of a wind turbine blade, advantageously without experiencing stresses from the blade, and having the possibility of being removed and refitted again, being a discrete and independent relative to the structure to be measured.

The device of the present disclosure is thus capable of measuring the original shape and consequent deflections of a wind turbine blade in terms of flapwise, edgewise or torsion. The device of the present disclosure is also capable measuring the original shape and deflection of a structure without knowing its design profile or material. The fibre optic device of the present disclosure is also capable of measuring a precise shape immune to temperature changes.

Advantageously, the measurement device of the present disclosure can be mounted, unmounted and refitted again in the same or a different placement.

Advantageously, the fibre optic device of the present disclosure is capable of measuring shape and deflection of a structure, e.g. a wind turbine blade, without experiencing stresses from the structure, wind turbine blade.

Advantageously, the fibre optic device of the present disclosure is capable of measuring three-dimensional shape of very large structures, for example 150-meter blades, with a reduced number of sensors and sections (for example, 5 to 20) and improved long-term stress resistance, without impairing measurement precision.

Advantageously, the fibre optic device of the present disclosure for measuring shape and deflection can be mounted inside or outside of a wind turbine blade.

The device of the present disclosure can be thus be used to reliably compare the structural behaviour of different blades.

The device of the present disclosure is precise and reliable enough to provide information to control a wind turbine in terms of pitch and yaw controls.

The shape sensor device of the present disclosure can be manufactured on one facility and easily mounted or refitted on a blade in other location, being easily transported when rolled.

The device of the present disclosure includes the following advantages:
Measure the precise shape without being fully fixed or bonded to the structure
No need to know the profile design to measure the shape
Use of a very reduced number of sensors vs the length of the structure to be measured
It allows for the unmounting and refitting of the same shape system
It is immune to temperature changes
No need for on-site calibration
100-meter shape sensors can be easily rolled and shipped in boxes
A shape sensing system to measure accurately the deflection of the entire length of a blade with a relatively low cost.
No need for special integration on the structure or blade.
Dispenses with gluing fibre optic sensors to the structure or blade.

It is disclosed a device for measuring a three-dimensional shape of a structure by being slidably coupled to the structure such that the deformation of the structure, except lengthening or shortening, causes a corresponding deformation of the device, comprising:
a pliant beam;
three or more optical fibres arranged lengthwise in parallel within said beam and having a transversal distance between said fibres in at least two different transversal directions;
wherein said optical fibres comprise a plurality of sensor regions distributed along said optical fibres,
wherein each said sensor region comprises a Fibre Bragg Grating in each of the optical fibres.

An embodiment comprises one or more slidable fittings for slidably coupling the beam to the structure to be measured.

An embodiment comprises a conduit for rigidly mounting onto the structure to be measured, wherein the beam is slidably mounted inside the conduit.

Optionally, the device may be rigidly fixed at one location to the structure. In particular, the device may be rigidly fixed to the structure at one of the ends of the beam.

Optionally, the device may be rigidly fixed at two or more locations to the structure. However, in this case the advantages associated with the slidable connection to the structure will no longer be present.

In an embodiment, the beam has a rectangular or quadrangular cross-section and device comprises four said optical fibres arranged in parallel within said beam forming a rectangle-shaped or a square-shaped optical fibre cross-section.

In an embodiment, the device comprises three said optical fibres arranged in parallel within said beam to sense deflection of the beam along a first direction, deflection of the beam along a second direction perpendicular to the first direction, and temperature.

In an embodiment, the device comprises four said optical fibres arranged in parallel within said beam to sense deflection of the beam along a first direction, deflection of the beam along a second direction perpendicular to the first direction, torsion of the beam, and temperature.

It is also disclosed a wind turbine blade or wind turbine tower comprising the device according to any of the disclosed embodiments.

In an embodiment, the device is installed inside the blade or mounted outside the blade, in particular on the trailing edge.

In an embodiment, the pliant beam comprises a plurality of parallel recesses along the length of the pliant beam.

The recesses are located at the external upper and lower surfaces of the pliant beam to embed the optical sensors and the optical fibres. With these recesses, the optical fibres and in particular the optical sensors are only affected by the shape or deflection or torsion of the pliant beam and not by other stresses external to the beam, when said beam is applied on the structure. Preferably, the optical fibre is embedded in a recess at a predetermined depth such that the optical fibre is not flush with the beam surface, in order to better protect the optical fibre from external stresses or pressures. Advantageously, the optical fibre is embedded in the recess and fixed using an adhesive, preferably an adhesive resin, more preferably an epoxy resin.

It is also disclosed a method for measuring a three-dimensional shape of a structure by using a device slidably coupled to the structure such that the deformation of the structure, except lengthening or shortening, causes a corresponding deformation of the device, the device comprising:
a pliant beam;
three or more optical fibres arranged lengthwise in parallel within said beam and having a transversal distance between said fibres in at least two different transversal directions;
wherein said optical fibres comprise a plurality of sensor regions distributed along said optical fibres,
wherein each said sensor region comprises a Fibre Bragg Grating in each of the optical fibres;
the method comprising the steps of:
determining the amounts of deflection, or deflection and torsion, in each said sensor region;
extrapolating the three-dimensional shape of the beam from the determined amounts;
using the extrapolated three-dimensional shape as the measured three-dimensional shape of the structure.

An embodiment of the disclosed method comprises the previous application of one or more slidable fittings to the structure for slidably coupling the beam to the structure to be measured.

An embodiment of the disclosed method comprises the previous rigidly mounting of a conduit onto the structure to be measured, wherein the beam is subsequently slidably arranged inside the conduit.

In an embodiment, the device comprises three said optical fibres arranged in parallel within said beam, and the method comprises determining deflection of the beam along a first direction, deflection of the beam along a second direction perpendicular to the first direction, and temperature.

In an embodiment, the device comprises four said optical fibres arranged in parallel within said beam, and the method comprises determining deflection of the beam along a first direction, deflection of the beam along a second direction perpendicular to the first direction, torsion of the beam, and temperature.

In an embodiment of the method, the device is previously installed inside the blade or mounted outside the blade, in particular on the blade trailing edge.

The beam may be made in polymer or may also be made from a composite material like a polymer base comprising embedded fibres, such as a glass-fibre based composite, for example using a polyvinyl-based polymer.

It is also disclosed a computer-implemented method for measuring a three-dimensional shape of a structure, using data obtained from a device slidably coupled to the structure such that the deformation of the structure, except lengthening or shortening, causes a corresponding deformation of the device, the device comprising:
a pliant beam;
three or more optical fibres arranged lengthwise in parallel within said beam and having a transversal distance between said fibres in at least two different transversal directions;
wherein said optical fibres comprise a plurality of sensor regions distributed along said optical fibres,
wherein each said sensor region comprises a Fibre Bragg Grating in each of the optical fibres;
wherein the method comprises carrying out the following steps by an electronic data processor:
determining the amounts of deflection, or deflection and torsion, in each said sensor region from readings of said Fibre Bragg Gratings;
extrapolating the three-dimensional shape of the beam from the determined amounts;
using the extrapolated three-dimensional shape as the measured three-dimensional shape of the structure.

It is also disclosed a non-transitory storage media including program instructions for implementing a method for measuring a three-dimensional shape of a structure, the program instructions including instructions executable by a data processor to carry out the method of any of the disclosed embodiments.

### BRIEF DESCRIPTION OF THE DRAWINGS

The following figures provide preferred embodiments for illustrating the disclosure and should not be seen as limiting the scope of invention.

FIG. 1: Schematic representation of an embodiment of the composition of a shape sensor device.

FIG. 2: Schematic representation of the principle used in embodiments of the disclosure being the difference of strain measurements.

FIG. 3: Schematic representation of a fibre optic array according to the disclosure.

FIG. 4: Schematic representation of the difference of strains find in each array depending on type of bending, torsion or temperature.

FIG. 5: Schematic representation of sliding sensor device applied to a structure.

FIG. 6: Schematic representation of different detection profiles with embedded arrays of FBGs according to embodiments of the disclosure.

FIG. 7: Schematic representation of the location of shape sensor installation on a wind turbine blade according to an embodiment of the disclosure.

FIG. 8: Schematic representation of a possible fixation of shape sensor device according to an embodiment of the disclosure.

FIG. 9: Schematic representation of a possible fixation means of the shape sensor device according to an embodiment of the disclosure.

FIG. 10: Schematic representation of an embodiment of the pliant beam comprising a plurality of recesses for receiving a fibre optic.

### DETAILED DESCRIPTION

The present disclosure relates to the field of measuring three-dimensional shapes of 3D structures, in particular wind turbine structures like wind turbine blades, using optical fibre strain sensors, namely Fibre Bragg Gratings, FBGs.

The present disclosure relates to a system comprised of a composite beam acting as a base layer with 2 or more arrays of parallel FBGs embedded along the composite beam.

In an embodiment, the beam can be between 1 to 200 meters with 5 to +20 sensorized sections.

In an embodiment, the device is fixed to the structure to precisely replicate the same shape of the structure onto the beam and then we can just measure the shape of the beam using the embedded FBGs.

In an embodiment, the beam shall be fixed on one of the ends and free on the rest, so that the beam does not experience the stresses of the structure when deflecting.

In an embodiment, the beam is arranged to slide through fixation pieces that are fixed to the structure.

In an embodiment, the shape sensor can be applied to the interior of the blade or on the outside of an existing blade.

In an embodiment, when the beam deflects, the FBGs on one of the sides will experience more strain then the FBGs on the other side, and the difference of strains is used to measure the curvature on each section. The knowledge of the composition and design of the beam allows for the extrapolation of shape for the rest of the beam between sections.

In an embodiment, the disclosure allows for the re-use of the same shape sensor device in different structures, and it allows the re-fitting on the same position, if needed.

In an embodiment, the use of 3 or 4 parallel arrays allows for the measurement of flapwise, edgewise deflection, torsion and with temperature compensation.

In an embodiment, by not being fixed or bonded to the structure, but free to move on one of the ends, allows the beam not to experience the stresses from the structure, only experiencing the shape and deflection.

In an embodiment, the higher the transversal distance between arrays and respective FBGs allows for a higher accuracy in terms of shape and deflection.

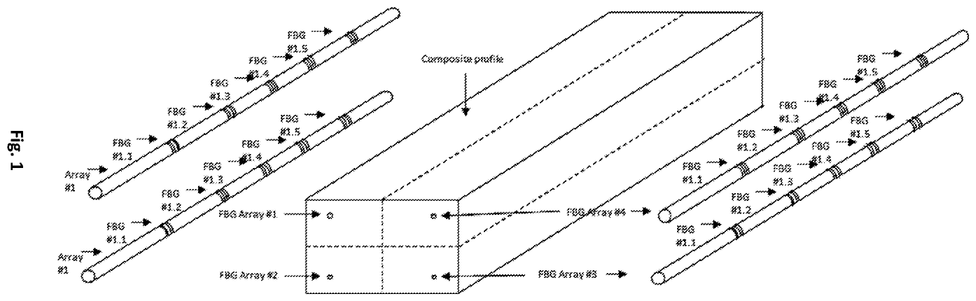

In an embodiment, the sensor of FIG. 1 comprises a composite beam and 3 or more parallel arrays of Fibre Bragg Gratings. In an embodiment, the rectangular shape of the beam allows for torsion measurements and a higher precision on the edgewise as needed, along with the possibility to roll up to be transported on a container.

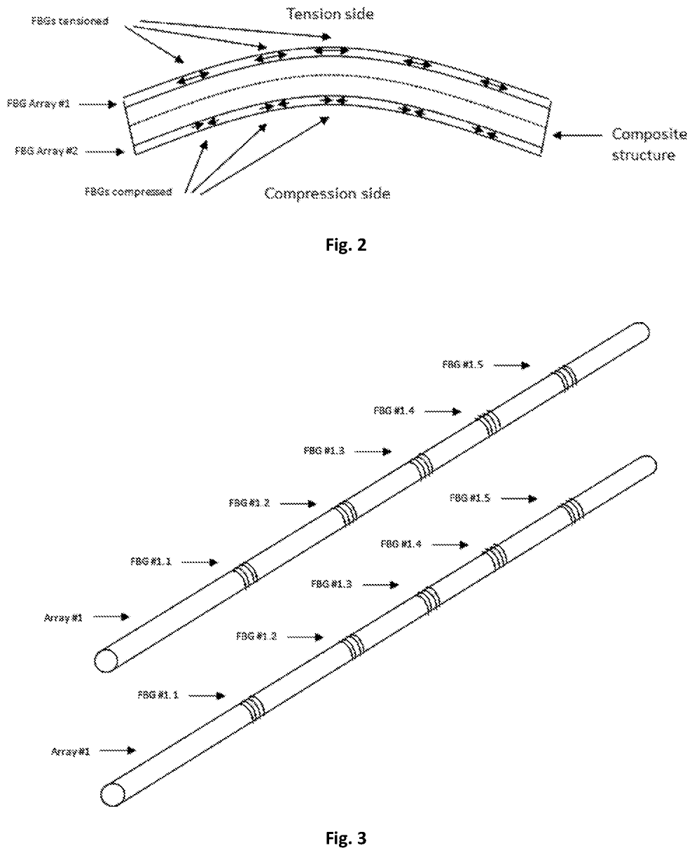

In an embodiment, FIG. 2 shows that a principle used is the difference of strains between the parallel arrays to calculate the curvature in each section. While one side is strained, the opposite is compressed.

In an embodiment, FIG. 3 shows that fibre Optic array containing 5 FBGs or more to measure the shape and curvature along the length of a wind turbine blade. In an embodiment, the number of sections used is based on the expected curvature and blade design.

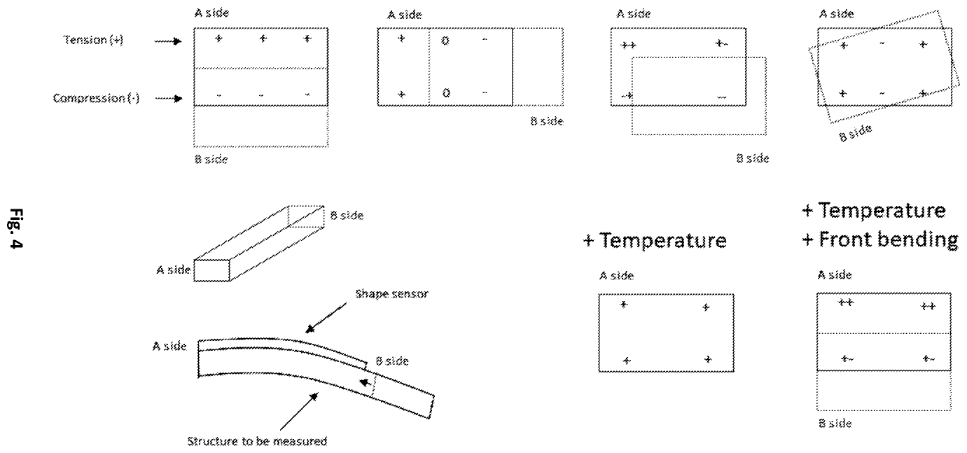

In an embodiment, FIG. 4 shows difference of strains find in each array depending on type of bending, torsion or temperature. This shows how to calculate each measurement for shape sensing works. The use of the beam allows a greater distance between sensors and is advantageous in the use of a rectangular beam with 4 single mode arrays instead of multicore fibres with 3 gratings in each section around a circular core.

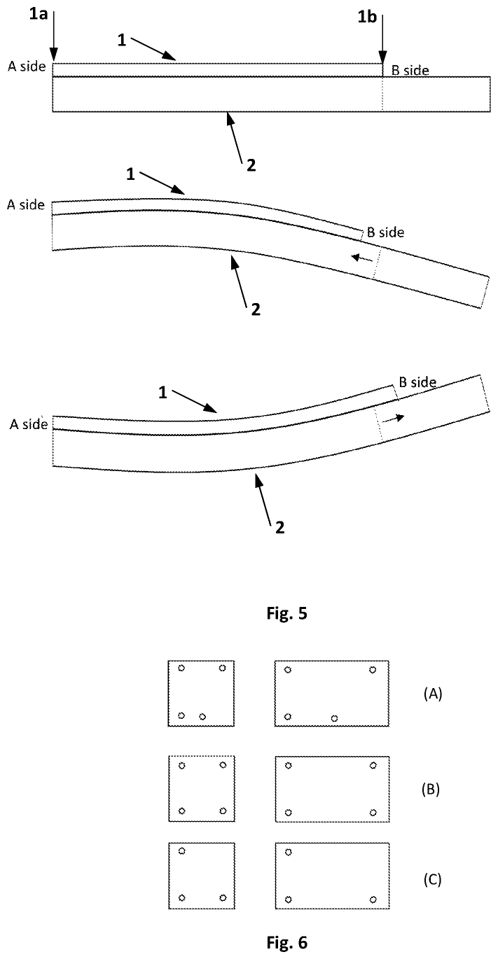

In an embodiment, FIG. 5 shows a sliding sensor 1 device applied to a structure or blade 2. The fixing pieces 1a and the free pieces 1b allow the shape sensor to slide during the bending of the structure, allowing the sensor to keep always the same length and experience reduced strains when compared to strains of the structure. This allows for the measurement of curvature without experiencing excessive strains. This process allows for the shape, curvature and deformation measurement of a structure without needing to know the design and specific profile of it, something critical for example for wind turbine blades.

In an embodiment, FIG. 6 shows different section profiles with embedded arrays of FBGs according to the disclosure. A shows a profile to measure 3D (flapwise and edgewise and torsion) and temperature compensation. B represents a profile to measure 3D (flapwise and edgewise) and temperature compensation with more precision. C represents a profile to measure 3D (flapwise and edgewise) and temperature compensation.

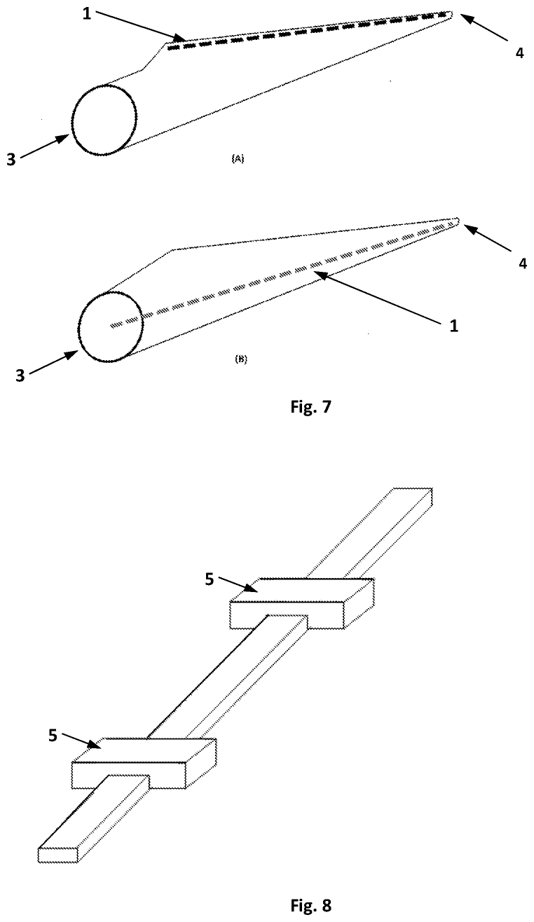

In an embodiment, FIG. 7 shows location of shape sensor 1 installation on a blade. The shape sensor can be mounted on the inside of the blade A, or in its outside B, by the trailing edge, in order for example not to disrupt the aerodynamic flow. Furthermore, in this figure, it is shown the root 3 and the tip 4 of the blade.

FIG. 8 shows a schematic representation of a possible fixation of shape sensor device according to an embodiment of the disclosure, where 5 are the fixing points.

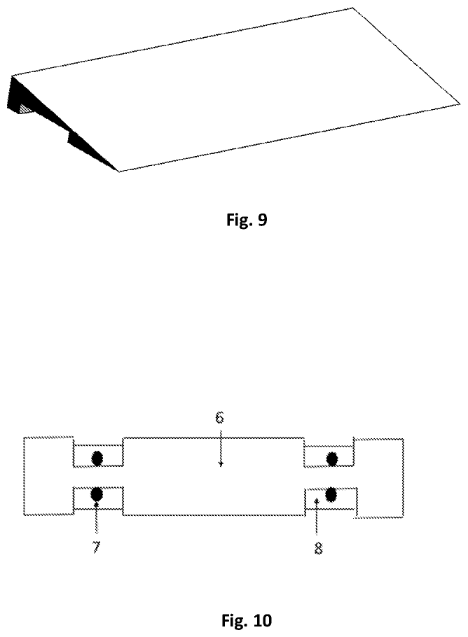

FIG. 9 shows a schematic representation of a possible fixation means of the shape sensor device according to an embodiment of the disclosure.

In an embodiment, FIG. 10, the pliant beam 6 comprises a plurality of parallel recesses along the length of the pliant beam. The recesses are located at the external upper and lower surfaces of the pliant beam to embed the optical sensors and the fibres 7. With these recesses, the optical sensors are only affected by the shape or deflection or torsion of the pliant beam and not by other external stresses when said beam is applied on the structure. The optical sensors can be glued or another fixation element 8 can be used.

In preferred embodiment, the number of recesses are 2 or more for the measurement of the shape and deflection in two dimensional shapes structure.

In an embodiment, the recesses are 3 or more for the measurement of the torsion in three dimensional shapes.

The term “comprising” whenever used in this document is intended to indicate the presence of stated features, integers, steps, components, but not to preclude the presence or addition of one or more other features, integers, steps, components or groups thereof.

The disclosure should not be seen in any way restricted to the embodiments described and a person with ordinary skill in the art will foresee many possibilities to modifications thereof.

The above described embodiments are combinable.

The following claims further set out particular embodiments of the disclosure.

1. A device for measuring a three-dimensional shape of a structure by being slidably coupled to the structure such that the deformation of the structure, except lengthening or shortening, causes a corresponding deformation of the device, comprising:
a pliant beam; and
three or more optical fibres arranged lengthwise in parallel within said beam and having a transversal distance between said fibres in at least two different transversal directions;
wherein said optical fibres comprise a plurality of sensor regions distributed along said optical fibres, and
wherein each said sensor region comprises a Fibre Bragg Grating in each of the optical fibres.

2. The device according to claim 1 further comprising one or more slidable fittings for slidably coupling the beam to the structure to be measured.

3. The device according to claim 1 further comprising a conduit for rigidly mounting onto the structure to be measured, wherein the beam is slidably mounted inside the conduit.

4. The device according to claim 1 wherein the beam has a rectangular or quadrangular cross-section and device comprises four said optical fibres arranged in parallel within said beam forming a rectangle-shaped or a square-shaped optical fibre cross-section.

5. The device according to claim 1 wherein the device comprises three said optical fibres arranged in parallel within said beam to sense deflection of the beam along a first direction, deflection of the beam along a second direction perpendicular to the first direction, and temperature.

6. The device according to claim 1 wherein the device comprises four said optical fibres arranged in parallel within said beam to sense deflection of the beam along a first direction, deflection of the beam along a second direction perpendicular to the first direction, torsion of the beam, and temperature.

7. The device according to claim 1 wherein the pliant beam comprises a plurality of parallel recesses along the length of said pliant beam, each recess for receiving one of the optical fibres.

8. The device according to claim 7 wherein each optical fibre is embedded in a recess at a predetermined recess depth and fixed with an adhesive resin.

9. A wind turbine blade or wind turbine tower comprising the device according to claim 1, wherein the structure to be measured is the wind turbine blade or wind turbine tower.

10. The wind turbine blade according to claim 9 wherein the device is installed inside the blade or mounted outside outside, trailing edge of the blade.

11. The wind turbine blade according to claim 10 wherein the device further includes one or more slidable fittings for slidably coupling the beam to the structure to be measured, wherein the fittings are mounted outside the blade and the beam is slidably coupled to said fittings.

12. The wind turbine blade according to claim 10 wherein the device further comprises one or more slidable fittings for slidably coupling the beam to the structure to be measured, wherein the conduit is installed rigidly inside the blade and the beam is slidably mounted inside the conduit.

13. A method for measuring a three-dimensional shape of a structure by using a device slidably coupled to the structure such that the deformation of the structure, except lengthening or shortening, causes a corresponding deformation of the device, the method comprising:
providing a pliant beam; and
arranging three or more optical fibres lengthwise in parallel within said beam and having a transversal distance between said fibres in at least two different transversal directions;
determining an amount of at least one of deflection and deflection and torsion, in each said sensor region;
extrapolating the three-dimensional shape of the beam from the determined amount of one of deflection and deflection and torsion; and
using the extrapolated three-dimensional shape as the measured three-dimensional shape of the structure;
wherein said optical fibres comprise a plurality of sensor regions distributed along said optical fibres, and
wherein each said sensor region comprises a Fibre Bragg Grating in each of the optical fibres;
determining the amounts of deflection, or deflection and torsion, in each said sensor region;
extrapolating the three-dimensional shape of the beam from the determined amounts;
using the extrapolated three-dimensional shape as the measured three-dimensional shape of the structure.

14. The method according to claim 13 further comprising before determining an amount of at least one of deflection and deflection and torsion, applying one or more slidable fittings to the structure for slidably coupling the beam to the structure to be measured.

15. The method according to claim 13 comprising before determining an amount of at least one of deflection and deflection and torsion, mounting a conduit onto the structure to be measured, wherein the beam is subsequently slidably arranged inside the conduit.

16. The method according to claim 13 wherein the beam has a rectangular or quadrangular cross-section and device comprises four said optical fibres arranged in parallel within said beam forming a rectangle-shaped or a square-shaped optical fibre cross-section.

17. The method according to claim 13 wherein the device comprises three said optical fibres arranged in parallel within said beam, for determining deflection of the beam along a first direction, deflection of the beam along a second direction perpendicular to the first direction, and temperature.

18. (canceled)

19. The method according to any of the claims 13-18 wherein the structure is a wind turbine blade or a wind turbine tower.

20. (canceled)

21. A computer-implemented method for measuring a three-dimensional shape of a structure, using data obtained from a device slidably coupled to the structure such that the deformation of the structure, except lengthening or shortening, causes a corresponding deformation of the device, the device comprising a pliant beam three or more optical fibres arranged lengthwise in parallel within said beam and having a transversal distance between said fibres in at least two different transversal directions, said optical fibres comprise a plurality of sensor regions distributed along said optical fibres,
and each said sensor region comprises a Fibre Bragg Grating in each of the optical fibres
the method comprising carrying out the following steps by an electronic data processor:
determining an amount of at least one of deflection, and deflection and torsion, in each said sensor region from readings of said Fibre Bragg Gratings;
extrapolating the three-dimensional shape of the beam from the determined amount of at least one of deflection, and defection and torsion; and
using the extrapolated three-dimensional shape as the measured three-dimensional shape of the structure.

22. A non-transitory storage media including program instructions for implementing a method for measuring a three-dimensional shape of a structure, the program instructions including instructions executable by a data processor to carry out the method of the claim 21.
